(19) United States
(12) Patent Application Publication
(10) Pub. No.: US 2025/0008021 A1
(43) Pub. Date: Jan. 2, 2025

(54) SYSTEMS AND METHODS FOR ARTIFICIAL INTELLIGENCE-BASED COACHING USING MICROLEARNING

(71) Applicant: JPMORGAN CHASE BANK, N.A., New York, NY (US)

(72) Inventors: Venkata GUNNU, Malvern, PA (US); Ami EHLENBERGER, Lansdale, PA (US); Walter SANDFORD, Dublin, OH (US); Mehul DOSHI, Plano, TX (US); Matthew RAY, Hilliard, OH (US); Zachary J HUTCHINS, Westerville, OH (US); Ramu KIZHAKKEY, Downingtown, PA (US)

(21) Appl. No.: 18/757,071

(22) Filed: Jun. 27, 2024

Related U.S. Application Data
(60) Provisional application No. 63/510,785, filed on Jun. 28, 2023.

(51) Int. Cl. H04M 3/51; G10L 15/16; G10L 15/26

(52) U.S. Cl. CPC H04M 3/5175; G10L 15/16; G10L 15/26; H04M 2203/403; H04M 2203/558

(57) ABSTRACT

In some aspects, the techniques described herein relate to a method and a system comprising one or more processors and one or more storage devices storing instructions that when executed by one or more processors, cause the processor to receive a text of a plurality of conversations between a plurality of customers and an agent; identify a context of one conversation of the plurality of conversation from one or more conversational insights; identify an intent of the one conversation from one or more conversational insights; and identify an area for training the agent based on the intent and the context.

### RELATED APPLICATIONS

This application claims priority to, and the benefit of, U.S. Provisional Patent Application Ser. No. 63/510,785, filed Jun. 28, 2023, the disclosure of which is hereby incorporated, by reference, in its entirety.

### BACKGROUND OF THE INVENTION

### 1. Field of the Invention

Embodiments are generally directed to systems and methods for artificial intelligence-based coaching using microlearning.

### 2. Description of the Related Art

Agents, such as customer service agents, go through multiple long documents as part of the training to learn new policies and how to tackle customer issues. The training materials are long and might only be remembered if used in near future. As a result, agents often refer to on-line help, such as knowledge management, or turn to colleagues for help. This affects the call handling time and the overall customer experience.

### SUMMARY

According to some embodiments, the techniques described herein relate to a method and a system comprising one or more processors and one or more storage devices storing instructions that when executed by one or more processors, cause the processor to receive a text of a plurality of conversations between a plurality of customers and an agent; identify a context of one conversation of the plurality of conversation from one or more conversational insights; identify an intent of the one conversation from one or more conversational insights; and identify an area for training the agent based on the intent and the context. further comprising identifying areas for training based on the plurality of conversations occurring during a time period.

According to some embodiments, the instructions may further comprise identifying areas for training the agent based on a record of the agent looking up information in the knowledge management database. The instructions may further comprise identifying areas for training the agent based on a use of a chatbot by the agent for information at a frequency above a threshold. The instructions may further comprise, after identifying areas to train the agent, querying the knowledge management database for information related to the identified areas. The instructions may further comprise through a user interface, the identified training to the agent. The instructions may further comprise that the identified training is provided in response to a new conversation about the identified training area. The instructions may further comprise that the identified training is provided when the agent has not received a customer call within a predefined time period.

### BRIEF DESCRIPTION OF THE DRAWINGS

FIG. 1 is a block diagram of a knowledge graph for competitor recognition.

FIG. 2 is a block diagram for a model framework for competitor recognition.

FIG. 3 is a block diagram of a computing device for implementing certain aspects of the present disclosure.

### DETAILED DESCRIPTION OF PREFERRED EMBODIMENTS

Systems and methods for artificial intelligence-based coaching using microlearning are disclosed.

Research has shown that people learn more and retain what they have learned better when they study in short, focused bursts than when they are forced to sit through hour long classes. Embodiments use artificial intelligence to create personalized, automated micro-learning moments to coach/educate agents. The micro-learning deep learning model may evaluate personalized documents, extract important content as “micro content,” and provide the micro content as coaching moments to the agent for effective learning.

Further, is of great benefit when considering millions of calls to have a consistent way of handling those calls, logging information, and providing learning tools in response to the calls. Doing so manually would take a proportional number of hours, which is an unbearable burden for any company handling such volume of calls. The methods and systems disclosed herein alleviate or eliminate these issues by methodically logging the calls, classifying them, and generating timely training in response to the calls.

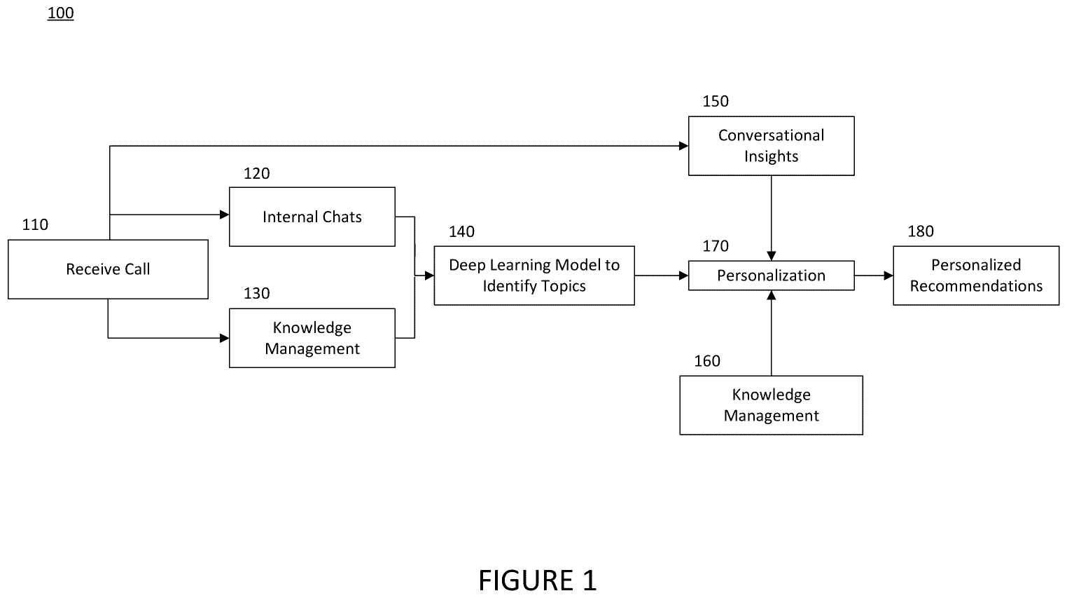

Referring to FIG. 1, a system and method 100 for identifying and presenting personalized training is disclosed according to an embodiment. An agent, such as a customer service agent, may interact, in real time, in a conversation with a customer via voice (e.g., via phone), text (e.g., via chat), etc.

Step 110 can include receiving a call. The call may be received and it can be processed with a voice-to-text conversion. During the interaction, the agent may seek information, such as an answer to a question, information about a product, etc. to respond to an inquiry from the customer.

The agent may engage with an internal chat, through step 120, to find an answer. The internal chat can be an interface with other agents and/or through a chatbot or machine learning system. To do this, the agent may consult a knowledge management system, through step 130, such as a database of information for the agent, and/or may chat with other agents.

In step 140, while the agent is using an internal knowledge management system, a search engine, or internal chats, a deep learning model, such as a neural network, may identify topics that the agent is searching for in the knowledge management searches and/or the internal chats. The deep learning model may receive text of internal chats, the customer call, and/or searches of the knowledge database. From this, the deep learning model may identify the customer's intent for the conversation.

The deep learning model may be any suitable machine learning model that may be trained using historical data. In one embodiment, each agent may have its own deep learning model; in another embodiment, a common deep learning model may be provided.

In step 150, the deep learning model can convert the text into a tabulated list that summarize the intent and/or context. The intent and/or context can form a conversational insight. Intent can be determined through keywords or phrases. Context can be determined through a classification model based on keywords and phrases. A database can be searched to align keywords and phrases with a particular classification. A large number of classifications can be used in a tiered system that includes a category, subcategory, and sub-subcategory. Further tiers are contemplated.

In step 170, a computer program, such as a personalized training computer program, can receive conversational insights from step 150, including an intent and/or a context. T

The intent and/or context can be used to identify areas for training the agent. The personalized training computer program may perform this action for more than one conversation; for example, the agent's conversations over a period of time (e.g., an hour, day, week, etc.). For example, the personalized training computer program may identify areas for training on a daily basis, weekly basis, monthly basis, or as necessary and/or desired. In some embodiments, the information from several calls can be aggregated in step 150 before being sent to step 170. Step 170 can use information from step 140 and step 150 to identify where, for example, an agent has both searched (e.g., step 130) or chatted (e.g., step 120) about specific talks and had a customer call about the same topics. For example, if an agent is looking up information in the knowledge management database and/or chatting for information at a frequency above a threshold, the personalized training computer program may be triggered to identify areas for training the agent. The personalized training computer can also combine that information with a context and/or an intent collected from a customer call to determine if multiple questions or issues concerning the same topic have arisen.

An identified area for training can be a cross section between a customer call (or an aggregate of customer calls) and one or more of an internal chat and an internal search. An identified area can be a topic, a subject of a training in a training database, and/or a program covering the topic and related topics.

Once the personalized training computer program has identified areas to train the agent, it may then query the knowledge management database, in step 160, which may be the same database that an agent may access for information, for information related to identified areas. The result can be personalized recommendations 180.

The personalized training computer program may then present the personalized training to the agent. The personalized training may be presented at specific times, at random times, during in a lull in customer conversations, in response to an event (e.g., a conversation with a customer related to a training topic), as requested, or as otherwise necessary and/or desired. The personalized training may be presented at a period of time after a call has taken place relevant to the subject matter of the personalized training, but not the original call.

The personalized training computer program can generate training based on the personalized training. The personalized training computer program can present quizzes, selectable graphical user interfaces, articles, and/or videos, that relate to the personalized training. The personalized training computer program may score a user's answer or effort. The video can be an entire video from a database or the video can be a truncated version of a video that only shows a portion relevant to the personalized training. The video can be analyzed for relevance to categories based on materials accompanying the video and/or the script of the video. The personalized training program can determine a high correlation between the materials and/or script or content of a training presentation and the identified area for training. The personalized training program can perform synonym analysis and matching, if the high correlation cannot be determined.

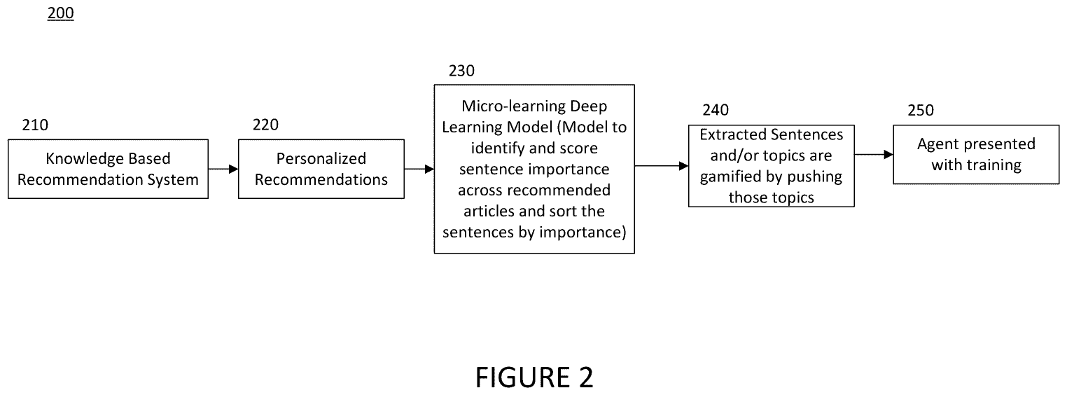

Referring to FIG. 2, a system and method for presenting microlearning is disclosed according to an embodiment. For example, once personalized training is identified for an agent, it may be presented as microlearning.

In embodiments, a micro-learning deep learning model 210 may use artificial intelligence to create personalized automated micro-learnings moments 220 to coach/educate agents. For example, the micro-learning deep learning model may review personalized documents, such as information retrieved from a knowledge management database, extract important content, and provide that micro content as coaching moments to the agent for effective learning. Based on the identified context, the micro-learning deep learning model can identify an article related to the content. The micro-learning deep learning model can also produce prompts and/or queries to generate the micro-learning content and trivia with the given intent.

In one embodiment, in step 230, the micro-learning deep learning model may identify and score sentence importance across recommended articles retrieved from knowledge management. It may then sort the sentences by the importance score.

Next, in step 240, the extracted sentences and/or topics may be presented to agent in a gamified manner. For example, the sentences and/or topics may be presented as “Did you know” messages that may be presented on the agent's screen, delivered by SMS, a quiz, or through a learning program. The presentation may occur through a user interface.

In one embodiment, in step 250, the agent may be periodically presented with training. For example, a quiz or similar based on the sentences/topics that have been previously presented. A scoreboard may be kept that displays a score across all agents if desired.

In one embodiment, the agent may be periodically re-evaluated to determine the effectiveness of the micro-learning.

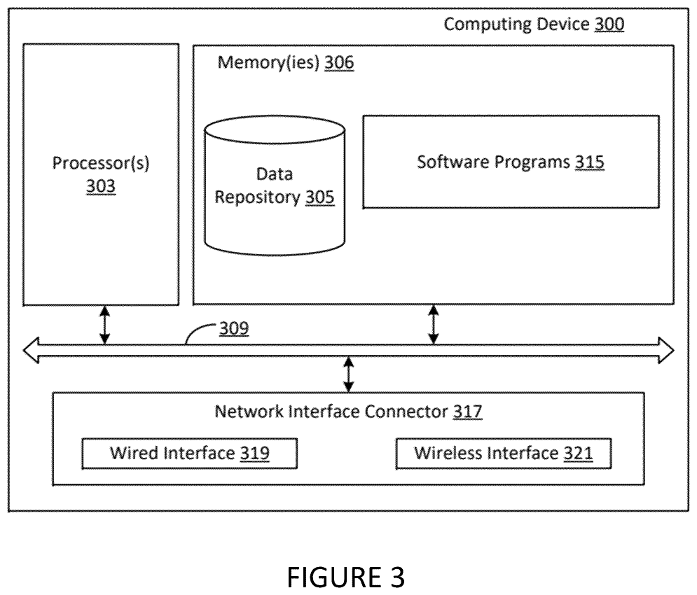

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A system comprising one or more processors and one or more storage devices storing instructions that when executed by one or more processors, cause the processor to:
receive a text of a plurality of conversations between a plurality of customers and an agent;
identify a context of one conversation of the plurality of conversation from one or more conversational insights;
identify an intent of the one conversation from one or more conversational insights; and
identify an area for training the agent based on the intent and the context.

2. The system of claim 1, further comprising identifying areas for training based on the plurality of conversations occurring during a time period.

3. The system of claim 1, further comprising identifying areas for training the agent based on a record of the agent looking up information in the knowledge management database.

4. The system of claim 1, further comprising identifying areas for training the agent based on a use of a chatbot by the agent for information at a frequency above a threshold.

5. The system of claim 1, further comprising providing, through a user interface, the identified training to the agent.

6. The system of claim 5, wherein the identified training is provided in response to a new conversation about the identified training area.

7. The system of claim 1, wherein the identified training is provided when the agent has not received a customer call within a predefined time period.

8. A method performed by one or more computers, the method comprising:
receiving, by an audio recording text and as a result of a speech-to-text conversion, a text of a plurality of conversations between a plurality of customers and an agent;
identifying, by a model, a context of one conversation of the plurality of conversation from one or more conversational insights;
identifying, by the model, an intent of the one conversation from one or more conversational insights; and
identifying, by the model, an area for training the agent based on the intent and the context.

9. The method of claim 8, further comprising identifying areas for training based on the plurality of conversations occurring during a time period.

10. The method of claim 8, further comprising identifying areas for training the agent based on a record of the agent looking up information in the knowledge management database.

11. The method of claim 8, further comprising identifying areas for training the agent based on a use of a chatbot by the agent for information at a frequency above a threshold.

12. The method of claim 8, further comprising, after identifying areas to train the agent, querying the knowledge management database for information related to the identified areas.

13. The method of claim 8, further comprising providing, through a user interface, the identified training to the agent.

14. The method of claim 13, wherein the identified training is provided in response to a new conversation about the identified training area.

15. The method of claim 8, wherein the identified training is provided when the agent has not received a customer call within a predefined time period.

16. A computer processing system comprising:
a memory configured to store instructions; and
a hardware processor operatively coupled to the memory for executing the instructions to:
receive a text of a plurality of conversations between a plurality of customers and an agent;
identify a context of one conversation of the plurality of conversation from one or more conversational insights;
identify an intent of the one conversation from one or more conversational insights; and
identify an area for training the agent based on the intent and the context.

17. The instructions of claim 16, further comprising identifying areas for training based on the plurality of conversations occurring during a time period.

18. The instructions of claim 16, further comprising identifying areas for training the agent based on a use of a chatbot by the agent for information at a frequency above a threshold.

19. The instructions of claim 16, further comprising providing, through a user interface, the identified training to the agent.

20. The instructions of claim 19, wherein the identified training is provided in response to a new conversation about the identified training area.
